(19) United States
(12) Patent Application Publication
(10) Pub. No.: US 2019/0226708 A1
(43) Pub. Date: Jul. 25, 2019

(54) SYSTEM AND METHOD FOR OPTIMIZING PERFORMANCE OF CHILLER WATER PLANT OPERATIONS

(71) Applicant: Siemens Industry, Inc., Alpharetta, GA (US)

(72) Inventor: Jesse Craft, Oakland, CA (US)

(73) Assignee: Siemens Industry, Inc., Alpharetta, GA (US)

(21) Appl. No.: 15/876,747

(22) Filed: Jan. 22, 2018

(51) Int. Cl. F24F 11/49; F24F 11/76; F24F 11/64; G05B 19/418

(52) U.S. Cl. CPC F24F 11/49; F24F 11/76; F24F 11/46; G05B 19/41885; F24F 11/64

(57) ABSTRACT

Capabilities of a chiller water plant are modeled using operational data, equipment data, and system configuration data enabling changes to be made to the configuration data and report the resulting changes in performance of the model.

### TECHNICAL FIELD

The present invention relates generally to building automation system and more particularly to assessing chiller water plant operations.

### BACKGROUND

Most modern buildings are built with security systems, emergency systems, heating, ventilating, and air conditioning (HVAC) systems, all of which have many sensors and control devices. These systems together are commonly referred to as a building automation system (BAS). One category of HVAC systems is a chiller water plant (chilled water cooling plant). A typical chilled water cooling plant is comprised of one or more chiller(s), chilled water circulation pump(s), condenser water pump(s), and cooling tower(s), plus piping to interconnect these components and control valves and switches. The plant delivers chilled water to one or more cooling coils within the building that are used to transfer heat out of the supply air stream and into the chilled water. The design and planning of a chiller water plant is typically done at a gross level with educated guesses being used for operational parameters and a building's efficiency. Often such guesses result in less than optimal performance of the chiller water plant. Also, when changes are made to the chiller water plant the results are typically not totally understood until after the change is made.

In view of the foregoing, there is an ongoing need for systems, apparatuses and methods for evaluating the operation of water chiller plant and the identification of savings that are achievable and impacts when changes are made to a water chiller plant.

### SUMMARY

An approach is provided for analyzing the impact and methodology for optimizing performance of chiller water plant operations. A chiller plant optimizer device receives weather data, system configuration data, and operational data. The chiller plant optimizer then uses the received data and rules/formulas to model the chiller water plant over a time periods covered by the operational data. Additionally, the chiller plant optimizer provides a number of reports and graphs for the time periods covered by the operational data logs. The configuration data may then be changed and the resulting changes in the model's operation compared to the original model's operation. By trying potential operational and equipment changes using a model created with the actual operational data, optimal configurations and changes are identifiable.

Other devices, apparatus, systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is an illustration of a building automation system (BAS) with a chiller water plant in accordance with an example implementation.

FIG. 2 is an illustration of a processor controlled device executing a chiller plant optimizer for optimizing the operation of the chiller water plant of FIG. 1 in accordance with an example implementation.

FIG. 3 is a diagram of the water chiller plant of FIG. 1 in accordance with an example implementation.

FIG. 4 is a diagram of the data accessed by the chiller plant optimizer of FIG. 2 for the water chiller plant of FIG. 1 in accordance with and example implementation.

FIG. 5 is a diagram of the chiller plant optimizer of FIG. 2 generating a model in accordance with an example implementation.

FIG. 6 is a diagram of a window in a graphical user interface used to modify an existing model of FIG. 5 in accordance with an example implementation of the invention.

FIG. 7 is a table of error codes that can be generated by the chiller plant optimizer of FIG. 2 in accordance with an example implementation of the invention.

FIG. 8 is a diagram of the reports generation by the chiller plant optimizer of FIG. 2 that are associated with the model of FIG. 5 in accordance with an example implementation.

FIG. 9 is a flow diagram of the approach for the chiller plant optimizer of FIG. 2 to generate the model of FIG. 5 in accordance with an example implementation.

### DETAILED DESCRIPTION

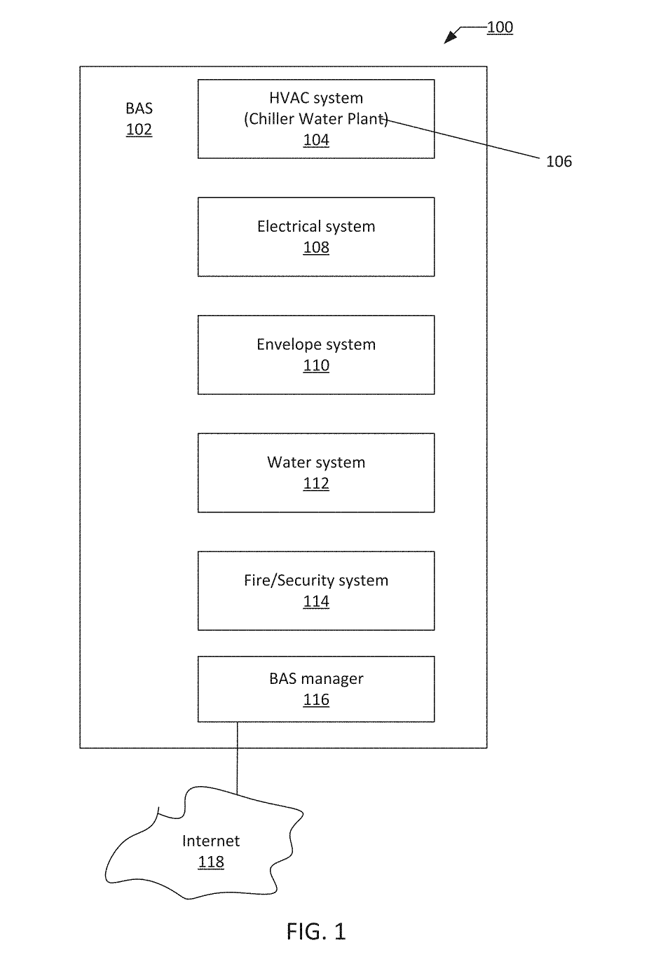

Turning to FIG. 1, an illustration 100 of a building automation system (BAS) 102 with a chiller water plant 106 in accordance with an example implementation. The BAS 102 typically has a number of subsystems, such as heating, ventilation and air condition (HVAC) system 104 (with chiller water plant 106), electrical system 108, envelope system 110, water system 112, fire/security system 114, and a manager or controller 116. In practice a number of points, controllers, panels, motors, sensors, and additional equipment may compose one or more of the systems. Further, other BAS may have additional or fewer systems and may be dependent upon the size of the building or campus being controlled. Current BAS with managers or controllers, such as 116 are connected to local networks and wide area networks (i.e. the cloud or internet 118).

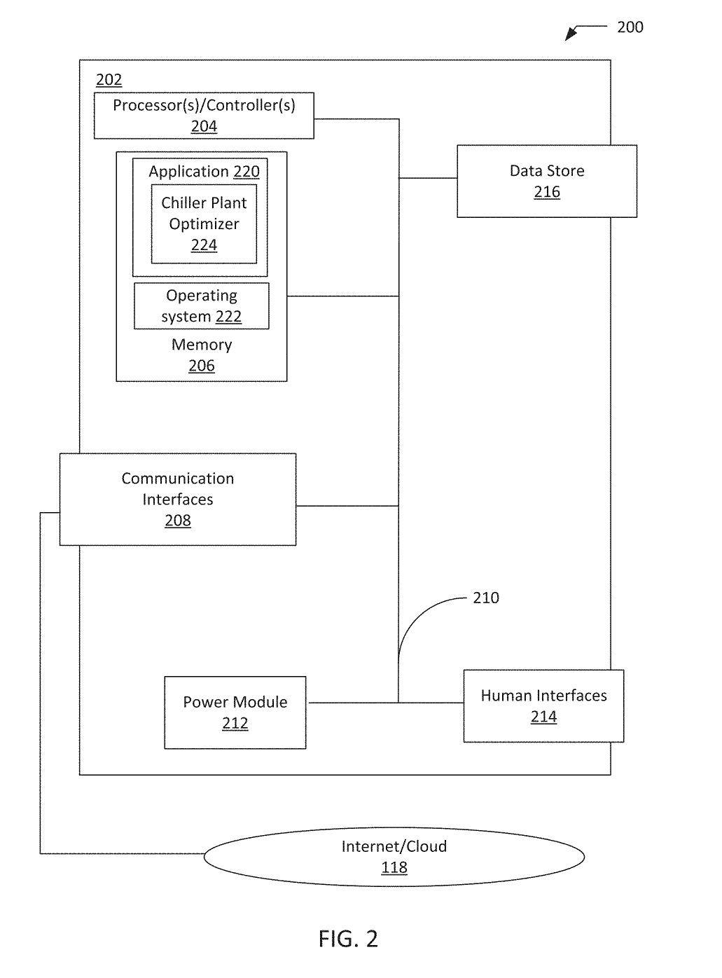

In FIG. 2, an illustration 200 of a processor controlled device 202 executing a chiller plant optimizer 224 for optimization of chiller water plant 106 of FIG. 1 in accordance with an example implementation. A processor or controller 204 is coupled to a memory 206, communication interfaces 208, power module 212, human interfaces 214, and data store 216 by bus 210. The bus 210 may be divided into a data bus and address bus. The memory 206 is divided into an application memory 220 and operating system memory 222. The communication interfaces 208 connect to other networks, such as the internet/cloud 118. The human interfaces 214 enable the processor controlled device 202 to monitors, keyboards, and mice. The monitors may display user interfaces that may be text or graphical based (graphical user interface). The data store 216 is typically an internal hard disk, but my be any type of permanent or semi-permanent memory device such as CDs, DVDs, hard disk drives, tape drives, solid state drives, or a combination of the previous. The instructions for the approach for evaluation of the viability of the BAS 102 is stored in application memory 220 and executed by the processor controller 204. It is noted that the processor controlled device 202 in other implementations may be reside remote or apart from the water chiller plant 106.

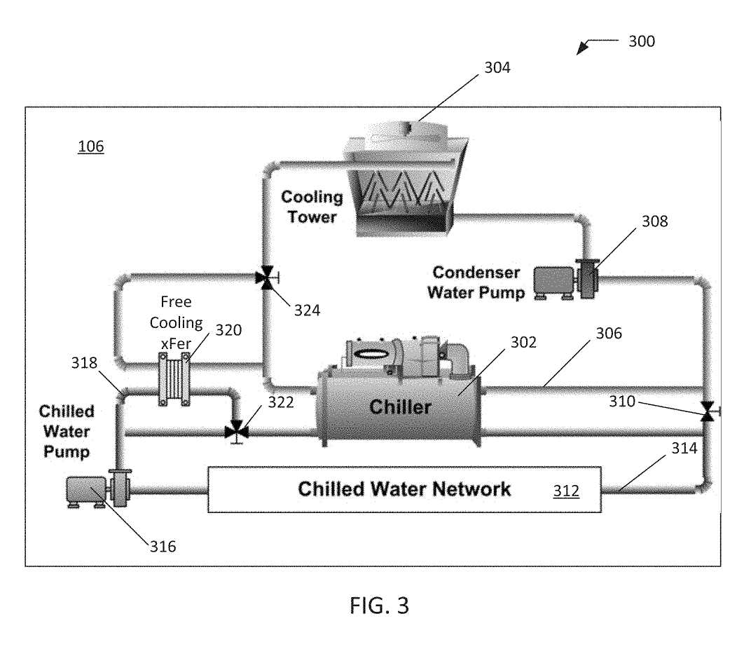

Turning to FIG. 3, a water chiller plant diagram 300 of the water chill plant 106 of FIG. 1 is shown in accordance with an example implementation. The chiller 302 is coupled to a cooling tower 304 via pipes 306 with water being circulated in pipes 306 via condenser water pump 308. A valve 310 keeps the circulating chilled water from the water of the chilled water network 312 that is used to cool a building. The chilled water flows through pipes 314 to chiller 302 via chilled water pump 316. Additional chilling of the chilled water may be accomplished by free cooling transfer 320 and controlled by valve 322. Warmed water returning to the cooling tower is routed through the free cooling transfer 320 via valve 324. So water in the upper loop circulates through the chiller 302 and cools the water in the lower loop. The water chiller plant 106 also has a number of sensors, switches, and valves that are connected to the BAS 102 that collects operational data from the water chiller plant 106.

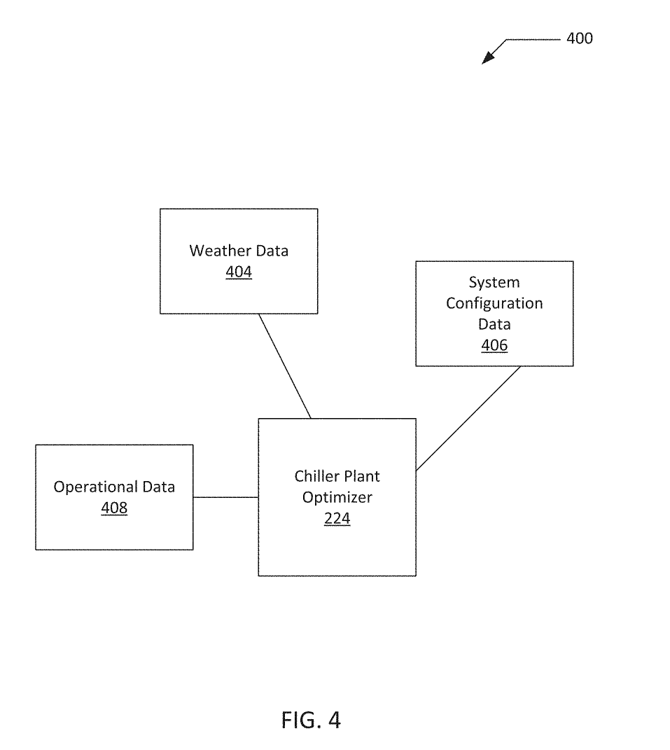

Turning to FIG. 4, a diagram 400 of the data accessed by the chiller plant optimizer 224 for the water chiller plant of FIG. 3 is depicted in accordance with and example implementation. The chiller plant optimizer 224 resides in the application memory 220 of a processor controlled device 202. The processor controlled device 202 may be an independent device that resides in BAS 102 or may be a server type device executing different programs including the chiller plant optimizer 224 program. The units of the data in the current implementation are United States standard units. In other implementations metric units may be used or in other implementations units used may be selectable based upon type of data being used. The chiller plant optimizer 224 accesses weather data 404, water chiller plant configuration data 406, and operational data 408. The weather data 404 may be accessed via the internet (for example www.wunderground.com) using a reference such as an airport code by the biller plant optimizer 224. Two types of weather data is accessed; Typical Meteorological Year (TMY3) data and contemporaneous meteorological data for a predetermined time period that preferably matches the time period of the operational data 406.

System configuration data 406 characterize and/or define the equipment employed in the water chiller plant 106. The number of chillers, pumps, and towers that are used in the water chiller plant 106 are identified. The equipment and sensors that are part of the water chiller plant 106 are generally referred to as points in a BAS, such as BAS 102 and contained in a BAS's database. The equipment includes evaporators, condensers, compressors, pumps, tower, and free cooling transfers. The points configuration data may be directly accessed by the chiller plant optimizer 224 or data files created by other tools may be accessed depending upon the implementation of the chiller plant optimizer 224. The capabilities and operational characteristics, such as flow rates, power consumption (typically in amps), cooling capacity, etc. are stored in a form accessible by the chiller plant optimizer 224. In some implementation, the data operation data and other data may be stored in the cloud and accessible via the internet or similar data network.

System configuration data 406 also includes identifying if compressor motors are variable frequency drives (VFDs), Approach temperatures (saturation temperature in the barrel of the chiller 302 and temperature of the leaving water), Design barrel pressure drops (if flow rate is recorded in pressure drops), minimum flow rates for the evaporator and condenser, wet bulb temperature for the cooling tower 304—a default of ASHRAE 1% design evaporation condition, pump/cooling tower (CT) efficiency—by default 90%, dry bulb temperature for cooling tower 304. In some chiller water plants, a mix of variable and constant speed pumps are present resulting in a speed as 60 Hz being entered for the constant speed pumps in the current implementation. In other implementations, other additional or different operation data may be used or included.

System configuration data, such as a header map is also created or otherwise made available to identify in the configuration data, where a header is identified by pieces of equipment being joined or connected. For example, where primary pumps and chillers join.

Operational data 408 is logged by the BAS 102 and contains data from monitoring points such as sensor and equipment running data such as flow rates (typically in gallons per minutes), supply water temperature, return water temperature, state of valves, amps and run loads of electrical devices, etc. The monitored data is stored by the BAS 102. The operational data 408 may be accessed for set time periods, such as days, weeks, or months.

The chiller plant optimizer 224 is able to be adapted to the size of the water chiller plant 106, access the weather data 404 (TMY3 and current weather), system configuration data 406 (design data and point maps), operational data 408 (chiller calibration and operational data) for selected or desired time periods. In the current example implementation, the weather data 404, system configuration data 406 and operational data 408 are accessed via the chiller plant optimizer via a network (network storage/cloud storage). In other implementations, part of all of the data may be located locally with (or on if a standalone device) the chiller plant optimizer 224.

The chiller plant optimizer 224, processes the data using a number of different approaches employing mathematical and empirical models and formulas, including the application of affinity laws (Also known as the “Fan Laws” or “Pump Laws”) for pumps/fans are used in HVAC to express the relationship between variables involved in pump or fan performance (such as head, volumetric flow rate, shaft speed) and power. Other fluid dynamics formulas may also be used when modeling the movement of liquid in the water chiller plant 106. They apply to pumps, fans, and hydraulic turbines. In these rotary implements, the affinity laws apply both to centrifugal and axial flows.

In the absence of operational data, the chiller plant optimizer 224 generates a linear profile for the base-case operation of the chiller 302 that assumes the chiller operates at the selected supply temperature and water flow assuming the chilled water supply is wet bulb+10 degrees chilled water set point (default is 75 degrees), whichever is warmer. Using those values, the chiller plant optimizer 224 calculates the chilled water return temperature and condenser water return temperature. With multiple chillers, a baseline secondary change in temperature is used to determine how much a chiller can be loaded up before the next one must start.

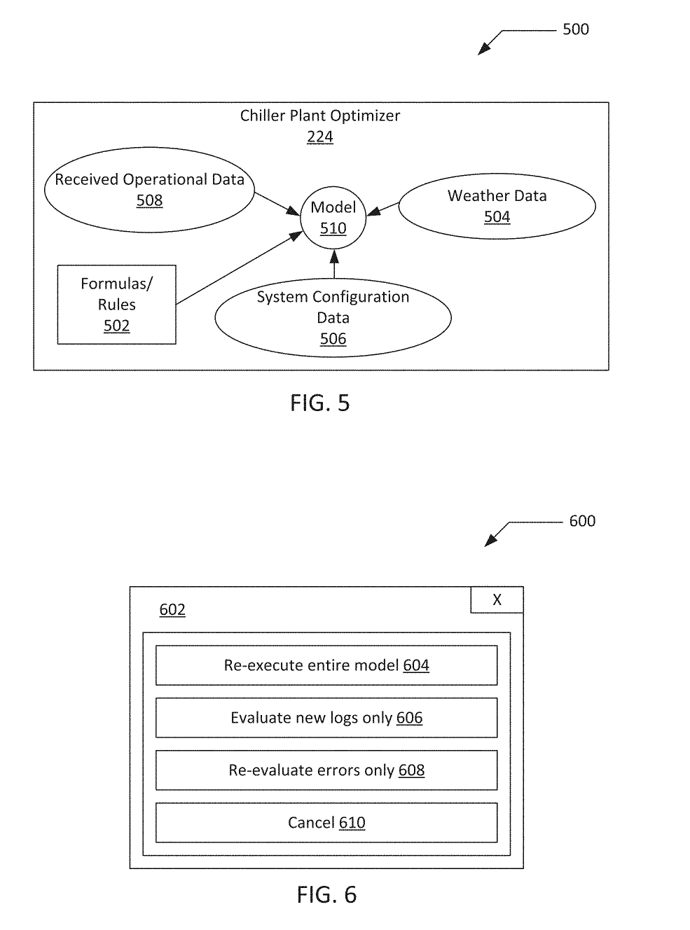

In FIG. 5, a diagram 500 of the chiller plant optimizer 224 of FIG. 2 generating a model 510 in accordance with an example implementation is depicted. The accessed or otherwise received weather data 504, received operational data 508, system configuration data 506, and formulas and rules 502 are used by the processor to generate a model 510 of the chiller water plant 104 for a predetermined periods (typically the periods of the logs). It is noted that the formulas are typically thermodynamic and fluid mechanics formulas used in the chiller plant optimizer, but the benefit of the approach is the creation and use of the model not the individual formulas. Each log from the received operational data 508 is evaluated and the results are recorded as results analysis data, chiller calibration data is recorded, and based upon the results data, the operating schedule for the chiller water plant 106 is evaluated (if the chiller water plant 106 was turned off at any time during the predetermined periods or if a HIGH/LOW occupancy split exist—i.e. trend data logs would typically be used. Baseline and chiller water plant performance is divided into temperature bins based upon the dry bulb temperature, and linear extrapolation occurs for any temperature bins not recorded in the data of received data. A load profile is calculated that includes total annual ton-hours, baseline kWh, and proposed kWh.

The resulting model data associated with model 510 is stored in the memory 206 of chiller water optimizer device 202. In other implementations, the resulting model data may be stored in other location, including external storage, network storage, and/or cloud storage.

Turning to FIG. 6, a diagram 600, of a window 602 in a graphical user interface used to modify an existing model 510 of FIG. 5 in accordance with an example implementation of the invention. In current implementation, the generation of the model 510 occurs in response to an instruction issued via a command issued (pushing a button) in a graphical user interface. If after generating a model, (such as model 510) logs, configuration, or data is changed or corrected the chiller plant optimizer 224 the model may be re-generated using “Re-execute entire model” button 604. If only new or changed logs are employed, the model 510 may be re-executed by selecting “Evaluate new logs only” 606. If errors were found in the generation of model 510, corrections may be made in the received data and the model 510 generated by selecting the “Re-evaluate errors only 608. The advantage of using the “Evaluate new logs only” 606 and “Re-evaluate errors only” 608 is the chiller plant optimizer 224 only needs to re-evaluate or generate only a portion of model, rather than the complete model 510. If no action is desired, “Cancel” 610 may be selected.

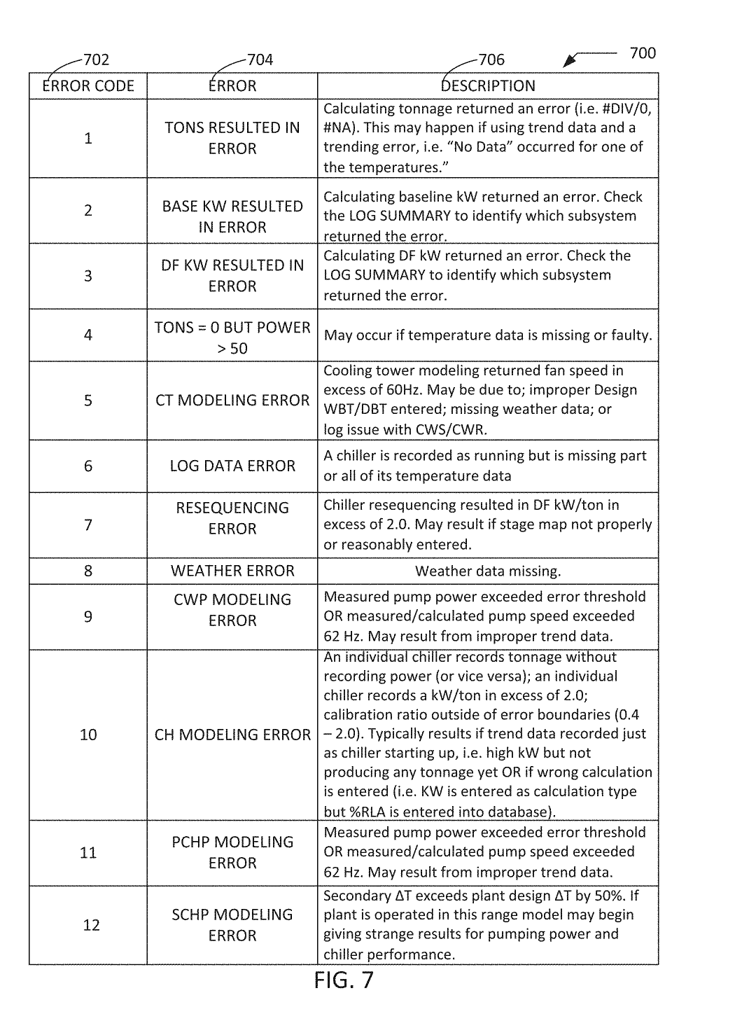

In FIG. 7, a table 700 of error codes 702 that can be generated by the chiller plant optimizer 224 of FIG. 2 is depicted in accordance with an example implementation of the invention. An error code 702 may be generated by the chiller plant optimizer 224 when generating a model 510. The error code 702 may display with the error 704 in a window of the graphical user interface alerting a user to the fact an error has occurred. Descriptions 706 of some example errors are provided. In other implementations, more or less error codes may be implemented.

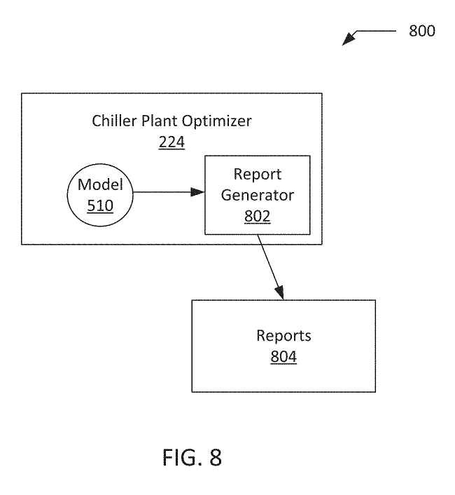

Turning to FIG. 8, a diagram 800 of the report 804 generation by the chiller plant optimizer 224 of FIG. 2 associated with model 510 of FIG. 5 in accordance with an example implementation. A report generator 802 generates reports associated with the model 510 generated by the chiller plant optimizer. The reports may be test files stored locally or remotely. The reports may be generated in response to selection of a button or menu in the graphical user interface associated with the chiller plant optimizer 224. A savings report is one of the reports 804 in the current example and indicates energy usage of the systems that make up the chiller water plant 106 and load profile. A measurement and verification report contains actual measured ton-hours and kWh evaluations for the equipment, target of ton-hours and kWh for a predicted operation of the equipment, and additional evaluations that may occur based on additional or different historic data. The reports are able to generate graphs when data is appropriate for such display. Furthermore, calibration data for the chiller water plant 106 may also be determined and reported via the reports 804.

An advantage of the current approach is the ability to replace hardware, such as chiller 302 and re-run the model resulting in an indication on performance changes. As the model was generated using data from the actual chiller water plant 106, the actual changes in performance are more accurate than application of theoretical model.

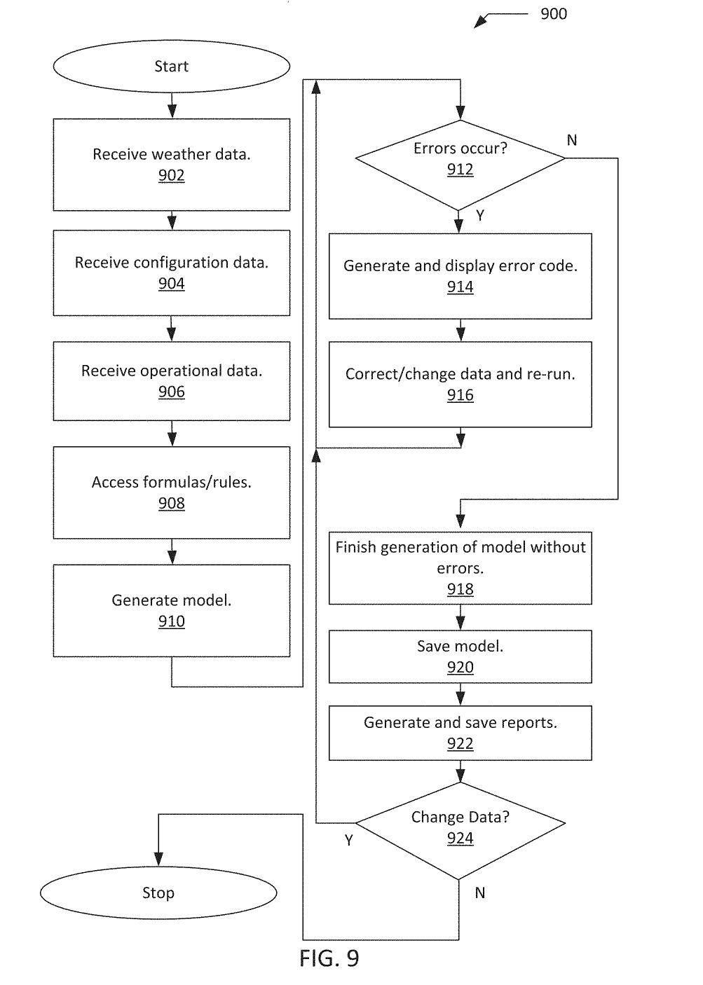

FIG. 9 is a flow diagram 900 of the approach for the chiller plant optimizer 224 of FIG. 2 to generate the model 510 of FIG. 5 in accordance with an example implementation. The chiller plant optimizer 224 receives or otherwise accesses the weather data in step 902. Configuration data is received or otherwise accessed in step 904. Operational data, such as log data is received or otherwise accessed in step 906. The chiller plant optimizer 224 then accesses the rules and formulas in step 908. A model of the chiller water plant 106 is then generated dependent on the received data in step 910. The rules and formulas being employed in the chiller plant optimizer 224 are used in conjunction of the recited data. Thus, the invention may use formulas, but is not the formulas.

If an error is detected in step 912 while generating the model in step 910, an error code is displayed in step 914. Otherwise, the model finishes generation in step 918. Changes and corrections may be made to the data in step 916 in order to correct errors. Processing of the model then continues and step 912 repeated. The finished model is saved in step 920 and reports are generated and saved in step 922. Data may be changed and the model re-run in step 924 to see what happens with hardware, operational periods, or temperatures are changed.

The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer readable medium may selectively be, for example, but is not limited to, an electronic, magnetic, optical, electromagnetic, or semiconductor system, apparatus or device. More specific examples, but nonetheless a non-exhaustive list, of tangible computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the tangible computer-readable medium may even be paper (punch cards or punch tape) or another suitable medium upon which the instructions may be electronically captured, then compiled, interpreted or otherwise processed in a suitable manner if necessary, and stored in a computer memory.

The foregoing detailed description of one or more embodiments of the approach for optimizing performance of chiller water plant operations has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A method for optimization of a chiller water plant with a chiller plant optimizer, comprising:
saving in a memory in response to a processor weather data, configuration data, and operational data associated with the chiller water plant;
generating with the processor, a model of the chiller water plant using the weather data, the configuration data, operational data along with rules and formulas stored in the memory;
creating a plurality of reports associated with the model of the chiller water plant; and
storing in the memory, the plurality of reports.

2. The method for optimization of the chiller water plant of claim 1, where saving weather data further includes,
saving typical meteorological year data in the memory.

3. The method for optimization of the chiller water plant of claim 1, where saving weather data further includes,
saving and contemporaneous meteorological data in the memory.

4. The method for optimization of the chiller water plant of claim 1, includes generating an error code in response to at least one error that occurs in the generation of the model.

5. The method for optimization of the chiller water plant of claim 1, where the operational data is for a predetermined timer period.

6. The method for optimization of the chiller water plant of claim 5, where the operational data includes trend data collected at predetermined time periods.

7. The method for optimization of the chiller water plant of claim 1, further includes re-generating the model with changes in the configuration data resulting in an updated model.

8. The method for optimization of the chiller water plant of claim 7, where the re-running further includes initiating the re-running via a graphical user interface.

9. A device that identifies optimization of a chiller water plant, comprising:
a memory in which weather data, configuration data, and operational data associated with the chiller water plant is saved in response to a processor;
a model of the chiller water plant generated by the processor using the weather data, the configuration data, operational data along with rules and formulas stored in the memory; and
a plurality of reports associated with the model of the chiller water plant created by the processor and stored in the memory.

10. The device that identifies optimization of the chiller water plant of claim 9, where the weather data further includes typical meteorological year data.

11. The device that identifies optimization of the chiller water plant of claim 9, where weather data further includes contemporaneous meteorological data.

12. The device that identifies optimization of the chiller water plant of claim 9, includes an error code generated in response to at least one error that occurs in the generation of the model.

13. The device that identifies optimization of the chiller water plant of claim 9, where the operational data is for a predetermined timer period.

14. The device that identifies optimization of the chiller water plant of claim 13, where the operational data includes trend data collected at predetermined time periods.

15. The device that identifies optimization of the chiller water plant of claim 9, further includes an updated model that results from the regeneration of the model with changes in the configuration data.

16. The device that identifies optimization of the chiller water plant of claim 15, where the updated model is initiated via a graphical user interface.

17. A tangible computer readable media having a plurality of instructions, that when executed preform a method for optimization of a chiller water plant with a chiller plant optimizer, comprising:
saving in a memory in response to a processor weather data, configuration data, and operational data associated with the chiller water plant;
generating with the processor, a model of the chiller water plant using the weather data, the configuration data, operational data along with rules and formulas stored in the memory;
creating a plurality of reports associated with the model of the chiller water plant; and
storing in the memory, the plurality of reports.

18. The method for optimization of the chiller water plant of claim 17, where saving weather data further includes,
saving typical meteorological year data in the memory.

19. The method for optimization of the chiller water plant of claim 17, where saving weather data further includes,
saving and contemporaneous meteorological data in the memory.

20. The method for optimization of the chiller water plant of claim 17, includes generating an error code in response to at least one error that occurs in the generation of the model.

21. The method for optimization of the chiller water plant of claim 17, where the operational data is for a predetermined timer period.
